(19) United States
(12) Patent Application Publication
(10) Pub. No.: US 2026/0216905 A1
(43) Pub. Date: Jul. 30, 2026

(54) System and Method to Cut Blocks of Meat

(71) Applicant: MP Equipment, LLC, Gainesville, GA (US)

(72) Inventors: Ernest Merrill, Gainesville, GA (US); Alex Maksymenko, Gainesville, GA (US); Nicholas Bowring, Gainesville, GA (US); Andrew Todd, Gainesville, GA (US); Nathan Kelley, Gainesville, GA (US)

(21) Appl. No.: 19/456,378

(22) Filed: Jan. 22, 2026

Related U.S. Application Data
(60) Provisional application No. 63/750,073, filed on Jan. 27, 2025.

(51) Int. Cl. B26D 5/00; A22C 21/00; B26D 7/06

(52) U.S. Cl. CPC B26D 5/007; A22C 21/0023; B26D 5/005; B26D 7/0625; B26D 2210/02

(57) ABSTRACT

A method and machine for cutting food in an automated manner is provided. The method preparing an image of a food block to be cut; comparing the image with a library of a plurality of annotated stored images of a same type, the annotations identify a predetermined anatomical feature and one or more additional and different anatomical features; establishing a most likely location of predetermined anatomical feature and the additional and different anatomical features based upon a comparison of visible features upon the image and the annotations upon the related images within the library, preparing a strategy for cutting based upon the established most likely locations, wherein the prepared strategy includes a cut line through the food block that is along a line along the predetermined anatomical feature; and cutting the food block based upon the prepared strategy.

### CROSS-REFERENCE TO RELATED APPLICATIONS

This application claims priority from U.S. Provisional Patent Application No. 63/750,073 , filed on Jan. 27, 2025, the entirety of which is incorporated by reference herein.

### TECHNICAL FIELD

The disclosure relates to a machine and a method used by the machine to cut a series of similar bulk food items that are presented upon a conveyor of the machine, such as chicken breasts, pork, beef, or the like into multiple pieces as desired either for immediate processing, baking or cooking, or packaging, refrigeration, freezing and the like. The machine using the method can cut presented bulk food items accurately and as desired by the user much faster than human operators could identify and cut bulk food items.

### BRIEF SUMMARY

A first representative embodiment of the disclosure is provided. The embodiment includes a method for cutting food in an automated manner. A machine that operates the method is also a representative embodiment, as well as a system that operates the method is provided. The method includes preparing a machine to cut a food block into two more pieces;
establishing a projected line along an inlet into the machine that references a location where a predetermined anatomical feature of the food block to be cut is positioned to align the food block to be properly cut within the machine and downstream of the inlet;
preparing an image of the food block from a side that faces upward when the food block is placed upon the inlet and upon the projected line;
receiving the food block upon the inlet;
comparing the image of the food block with a library that includes a plurality of stored images of a same type of food block, wherein the plurality of stored images are annotated to identify the predetermined anatomical feature as well as one or more additional and different anatomical features of the food block upon the image;
establishing a most likely location of predetermined anatomical feature and the one or more additional and different anatomical features of the food block that is received upon the inlet based upon a comparison of visible features of the food block upon the image and the annotations of the same predetermined and one or more additional and different anatomical features upon the plurality of stored images,
determining any offset between a position of the food block that is received upon the inlet and the projected line;
preparing a strategy for cutting the food block that is received upon the inlet based upon the established most likely locations of the two or more anatomical features of the food block that is received upon the inlet and the determined offset;
cutting the food block based upon the prepared strategy.

Another representative embodiment of the disclosure is provided. The embodiment includes a method for cutting food in an automated manner. A machine that operates the method is also a representative embodiment, as well as a system that operates the method is provided. The method includes preparing a machine to cut a food block into two more pieces. The method includes preparing a machine to cut a food block into two more pieces;
establishing a projected line along an inlet into the machine that references a location where a predetermined anatomical feature of the food block to be cut is positioned to align the food block to be properly cut within the machine and downstream of the inlet;
preparing an image of the food block from a side that faces upward when the food block is placed upon the inlet and upon the projected line;
receiving the food block upon the inlet;
comparing the image of the food block with a library that includes a plurality of stored images of a same type of food block, wherein the plurality of stored images are annotated to identify the predetermined anatomical feature as well as one or more additional and different anatomical features of the food block upon the image;
establishing a most likely location of predetermined anatomical feature and the one or more additional and different anatomical features of the food block that is received upon the inlet based upon a comparison of visible features of the food block upon the image and the annotations of the same predetermined and one or more additional and different anatomical features upon the plurality of stored images,
preparing a strategy for cutting the food block that is received upon the inlet based upon the established most likely locations of the two or more anatomical features of the food block that is received upon the inlet, wherein the prepared strategy includes a cut line through the food block that is along a line along the predetermined anatomical feature from a first outer edge of the food block either at or closest to a first determined end of the predetermined anatomical feature and to a second outer edge of the food block at an opposite side of the food block from the first outer edge and either at or closest to an opposite second determined end of the predetermined anatomical feature; and
cutting the food block based upon the prepared strategy.

Yet another representative embodiment is provided. The embodiment includes a method for cutting food in an automated manner. The method includes:
preparing a machine to cut a food block into two more pieces;
establishing a projected line along an inlet into the machine that references a location where a predetermined anatomical feature of the food block to be cut is positioned to align the food block to be properly cut within the machine and downstream of the inlet;
preparing an image of the food block from a side that faces upward when the food block is placed upon the inlet and upon the projected line;
receiving the food block upon the inlet;
comparing the image of the food block with a library that includes a plurality of stored images of a same type of food block, wherein the plurality of stored images are annotated to identify the predetermined anatomical feature as well as one or more additional and different anatomical features of the food block upon the image;
establishing a most likely location of the predetermined anatomical feature and the one or more additional and different anatomical features of the food block that is received upon the inlet based upon a comparison of visible features of the food block upon the image and the annotations of the same predetermined and one or more additional and different anatomical features upon the plurality of stored images,
determining any offset between a position of the food block that is received upon the inlet and the projected line;
preparing a strategy for cutting the food block that is received upon the inlet based upon the established most likely locations of the two or more anatomical features of the food block that is received upon the inlet and the determined offset;
cutting the food block along the predetermined anatomical feature based upon the prepared strategy, wherein the step of cutting the food block based upon the prepared strategy comprises cutting the food block along a path that is not a straight line along an entire length of the cut of the food block.

The specification can be readily understood with reference to one or more of the Numbered Paragraphs at the end of this specification and various combinations of these Numbered Paragraphs.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF DRAWINGS

FIG. 1 is a schematic view of a machine that is configured for cutting food blocks into desired pieces., the machine uses a method disclosed herein.

FIG. 1A is an image of a food block that is to be interpreted in accordance with the method.

FIG. 1B is the image of FIG. 1A of the food block with a cutting strategy that has been developed by the method provided schematically thereon.

FIG. 1C is the image of FIG. 1A schematically annotated to reflect various anatomical features and various attributes of the image as identified by the system 600.

FIG. 2A is a first image from the image library that is schematically annotated to reference the predetermined anatomical feature (121a) as well as several other identified anatomical features (122a, 123a, 126a).

FIG. 2B is a second image from the image library that is schematically annotated to reference the predetermined anatomical feature (121a) as well as several other identified anatomical features (122a, 123a, 125a, 126a). The image is also annotated with various different possible geometric relationships that may be mapped to the image to aid in comparing the library images with the image of the food product to be cut depicted in FIG. 1A.

FIG. 3 is a schematic drawing that depicts the portions the computing device 602 that performs the method.

FIG. 4 is another schematic drawing that depicts different portions of the computing device that performs the method.

FIG. 5 is a schematic flowchart of the method.

FIG. 6 is an image of a possible cutting strategy for a block food that has been scanned.

FIG. 6A is a detail view of detail DD of FIG. 6.

FIG. 7A is a schematic view of a cutting path (A) through a food block, with the figure depicting a cutting path positioned to cut a keel of a chicken breast, and depicting vector components Ay and Ax that exist to represent the components of the cutting path along its length.

FIG. 7B is a schematic view of a cutting path (A, 1811) depicting localized vector components Ay and Ax for a portion of the cutting path.

FIG. 7C is a schematic view of a cutting path (A, 1812) depicting localized vector components Ay and Ax for a portion of the cutting path.

FIG. 7D is a schematic view of a cutting path (A, 1813) depicting localized vector components Ay and Ax for a portion of the cutting path.

FIG. 7E is a schematic view of a cutting path (A, 1814) depicting localized vector components Ay and Ax for a portion of the cutting path, where the cutting path extends along a path that is similar to a sine wave.

FIG. 7F is a schematic view of a cutting path (A, 1815) depicting localized vector components Ay and Ax for a portion of the cutting path, where the cutting path extends along a path that is similar to a sine wave.

### DETAILED DESCRIPTION

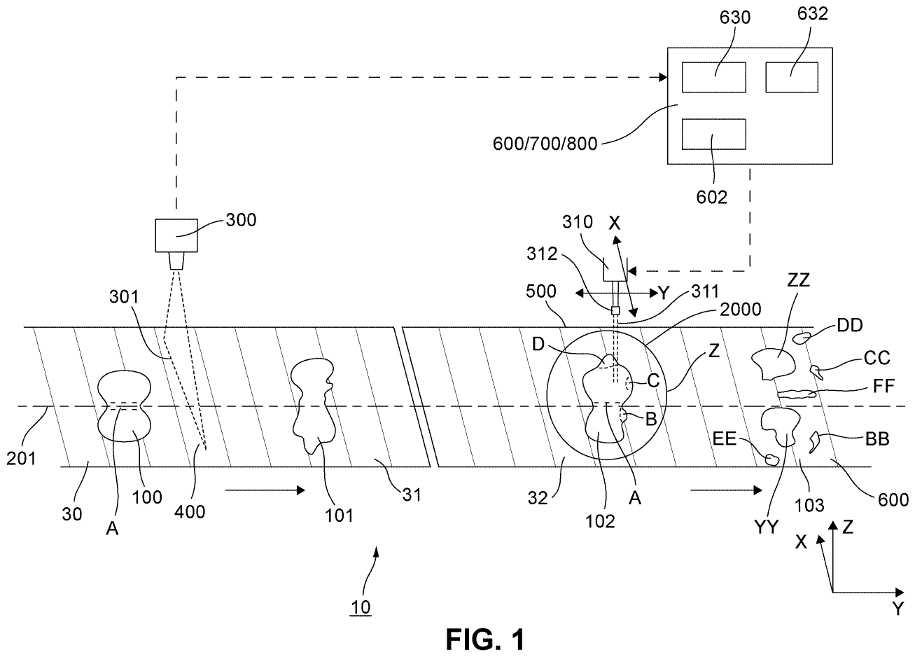

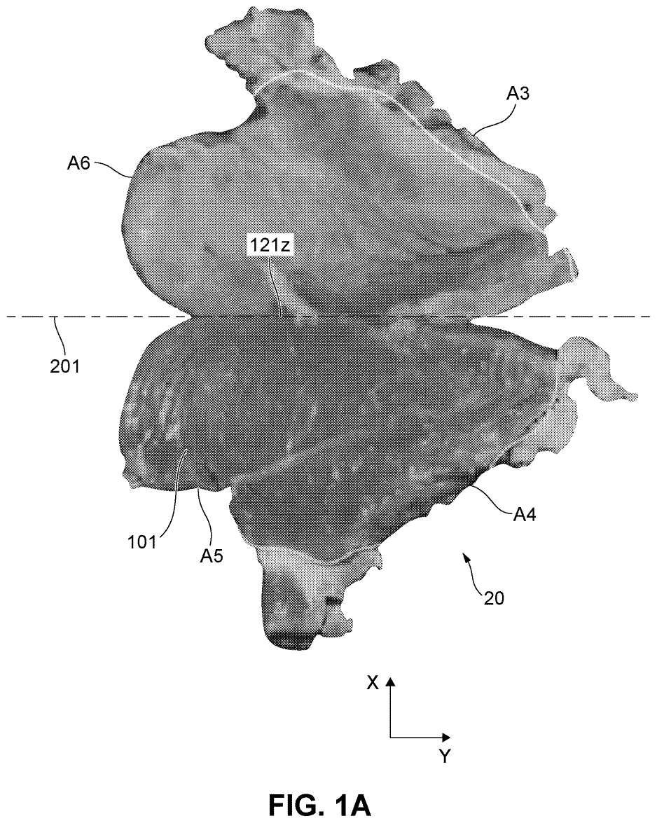

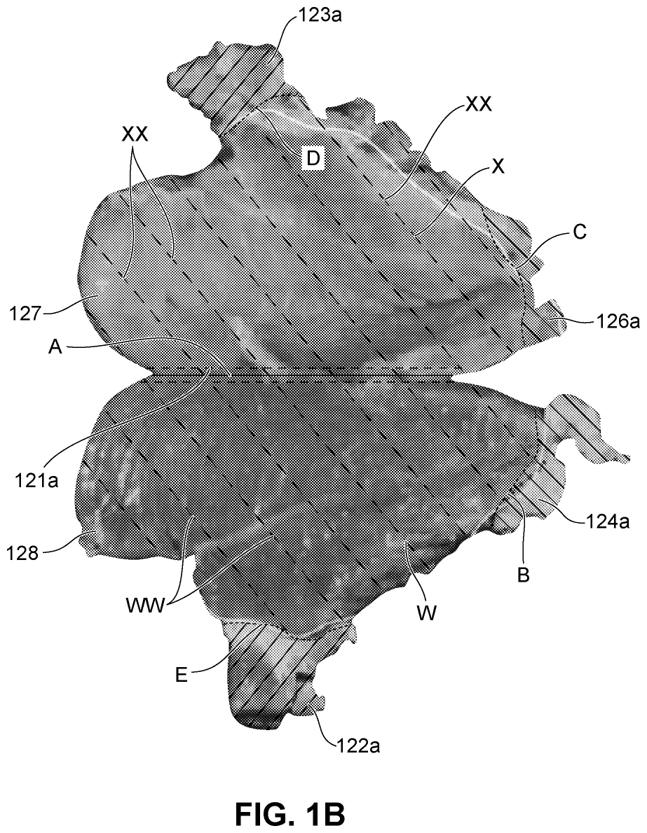

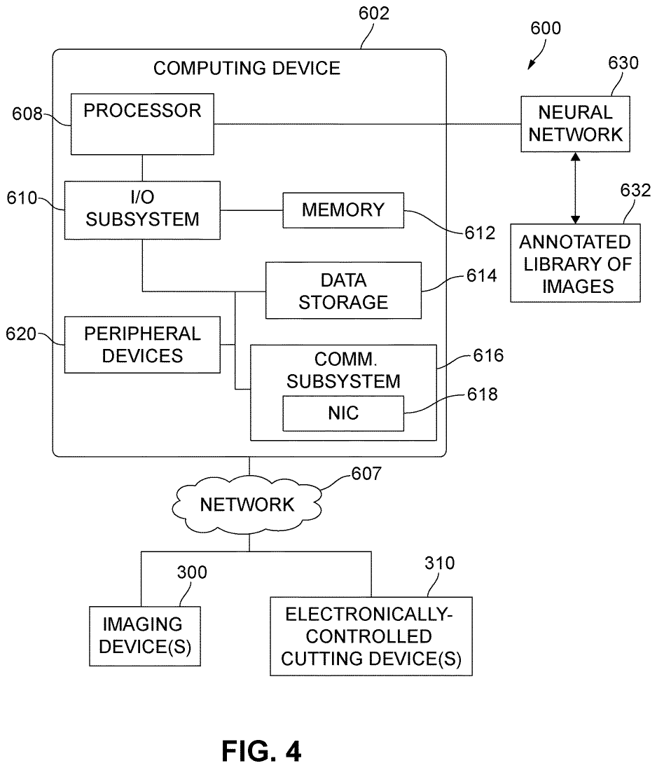

Turning now to FIGS. 1-7F, the subject disclosure relates to a process for identifying various expected anatomical features present within a food block (100, 101, 102, 103) that is presented to a machine to be cut into two or more pieces (section 103 of FIG. 1) for further processing, or for sale, or for cooking prior to consumption. The process for identifying the various expected anatomical features present within the food block allows for the system to establish a plan for cutting the food block within the machine to establish the two or more pieces of useful food block (YY, ZZ, section 103) as well as to cut off pieces that either have no nutritional value (FF, DD, BB, section 103), or are pieces that may have nutritional value but must be stored, cooked, sold, or used separately (e.g. DD, EE, section 103). The subject disclosure is drafted specifically for use with a system to process and cut meat blocks, such as chicken breasts, but can readily be adapted for other naturally occurring items (either animal or plant based) that are intended to be sold, such as for human or animal consumption. Other animal based food items could be chicken, pork, beef, fish, and the like.

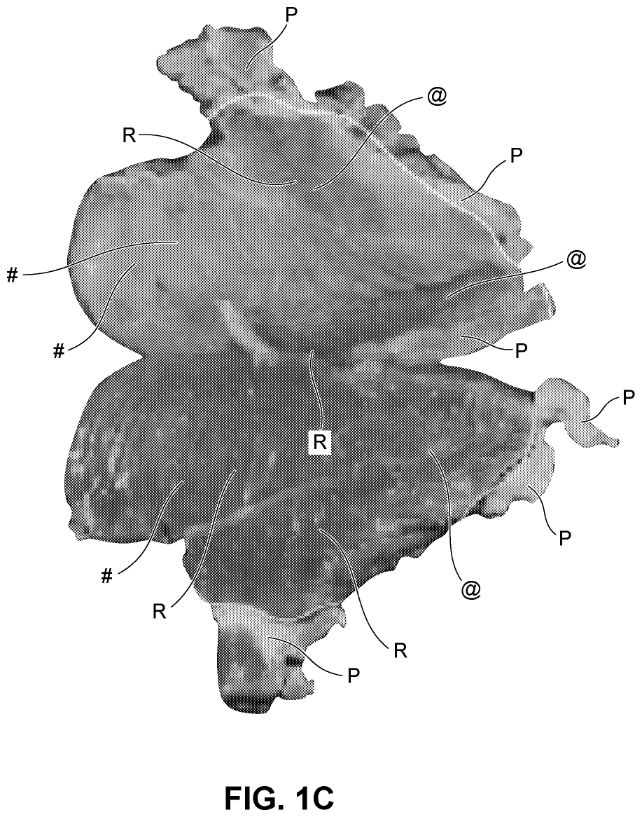

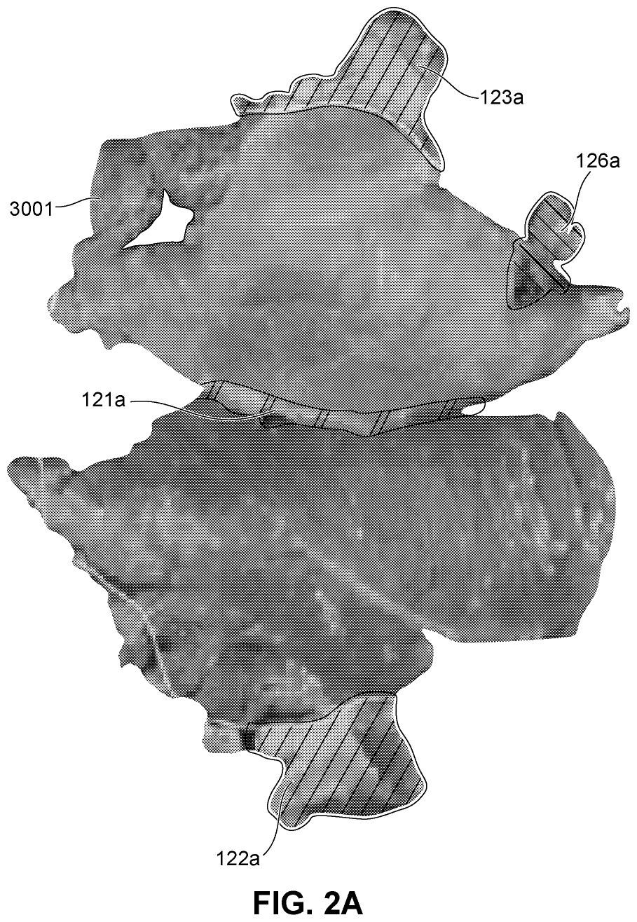

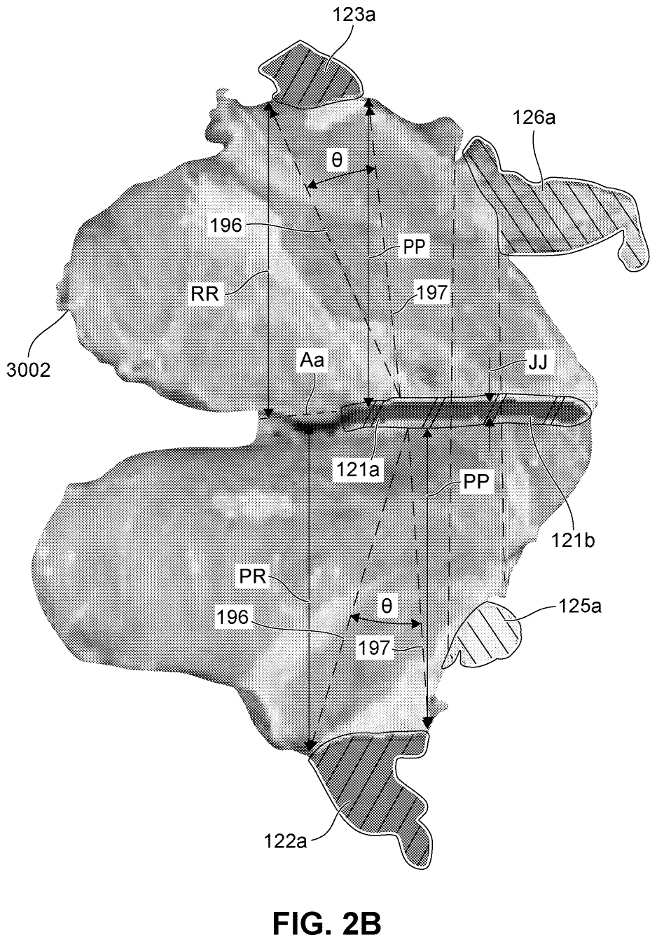

The disclosure relates to a machine 10 and method where individual bulk food blocks (100, 101, 102) are received upon a conveyor 30 and directed to a position within the machine 400 where an image of each of the individual food blocks is obtained in a serial manner. The machine, using the method, compares the image of the individual food block with a library of annotated images (e.g. FIGS. 2A, 2B) of the same type food block, and with the comparison (804) establishes the most likely location of a predetermined anatomical feature upon the image as well as the location of one or more additional and different anatomical features upon the image. The system using the method then prepares a strategy for cutting the food block (810) upon the conveyor 30 that corresponds to the image based upon the location of the predetermined anatomical feature (A—section 102, FIG. 1) and the location of the two or more anatomical features upon the food block (B, C, D, E—section 102, FIG. 1). The machine 10 then cuts the food block (30, 31, 102, FIG. 1) using the predetermined cutting strategy once the conveyor delivers the food block to a location within the machine where it is aligned to be cut by the one or more cutting features 30, 31 of the machine.

The cutting strategy 810/812 is determined with reference to the established most likely location of the predetermined anatomical feature of the food block as well as the identification of one or more other anatomical features of the food block, to cut the food block into different pieces as desired by the user of the machine (or the customer(s) of the user of the machine. For example, in the specific embodiments described herein with reference to meat blocks that are chicken breasts, the predetermined anatomical feature is the keel of the chicken breast (121a), and the cutting strategy may include a cut (A) along the keel to cut the chicken breast into two pieces, with one chicken breast piece in each piece. The cutting strategy may also include a step of removing ribmeat (122a, 123a,) that extends from each side (W, X, FIG. 1B) with cuts E, D of the chicken breast based upon the identification of the ribmeat in the establishing the most likely location of the ribmeat as discussed below. The cutting strategy may also include a step of removing rear edge fat (124a, 126a) from one or both sides W, X (depending upon the determined existence of the rear edge fat from one or both halves) with cuts B, C. The cutting strategy may also include other strategic cuts (WW, XX, FIG. 1B) within each chicken breast piece (that is made an individual piece when the food block is cut through the keel) to cut the pieces into for example, elongate strips (as depicted in FIG. 1B), smaller pieces for chicken nuggets, or the like. In some embodiments, the strategic cuts within each chicken breast piece may be performed by the machine after the initial cuts (A, B, C, D, E) described directly above are made, or may be performed by a separate machine that receives the chicken breast cut pieces from the machine that performs the method described herein.

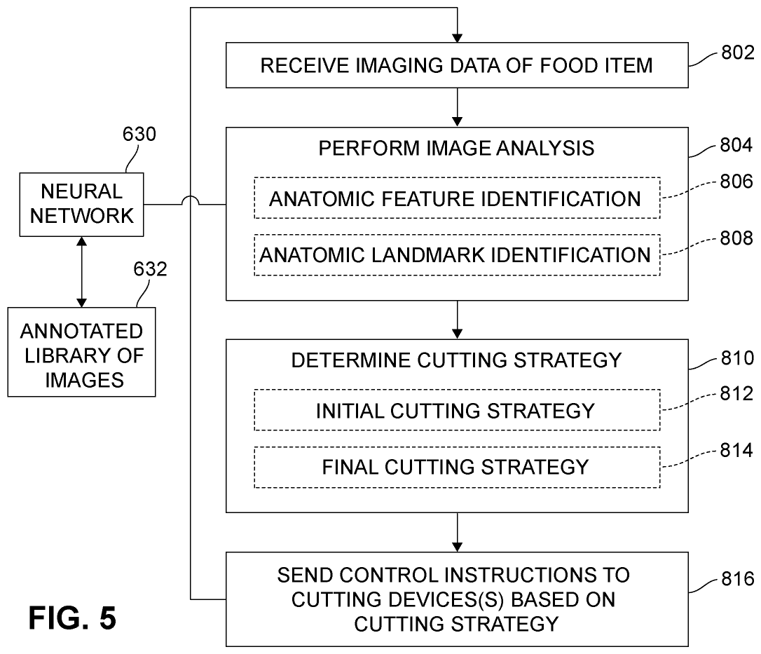

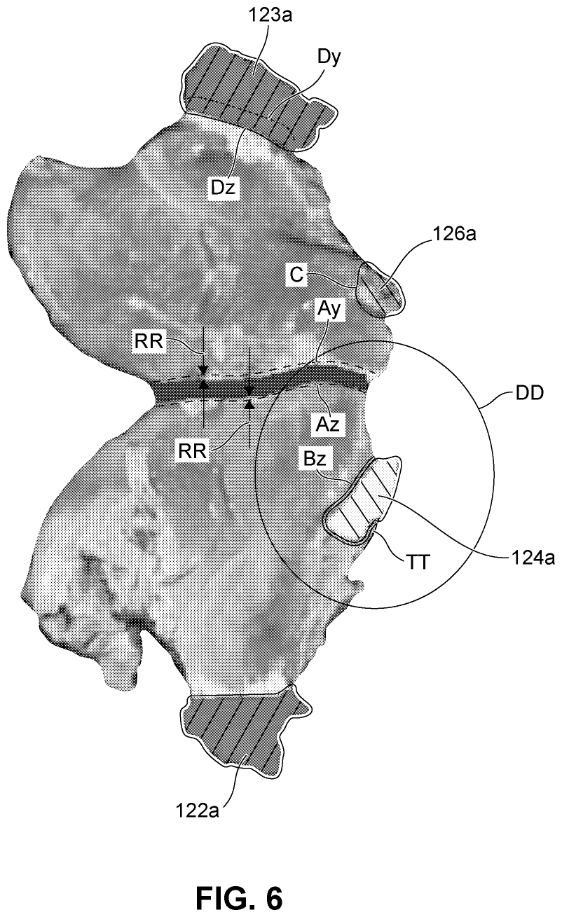

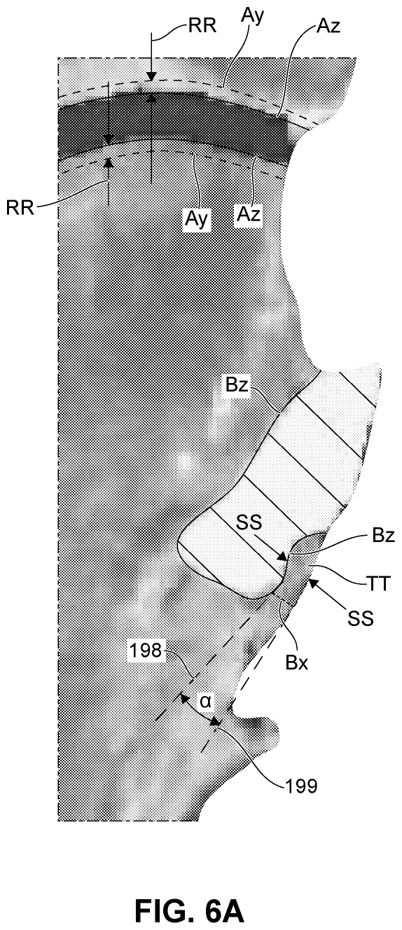

In some embodiments, one or more of the cuts may be altered (812/814—FIGS. 5, 6, 6A) within the method from a cut that would be optimized to solely make the desired cut (i.e. a cut to remove a ribmeat portion from the chicken breast). In this embodiment, the user (programmer) of the machine that uses the method may include preferences for the cutting strategy that are to be implemented when making the necessary cuts. For example, the user may program the software the operates the machine in that it is desired to make the cut of the keel (i.e. the predetermined anatomical feature in this embodiment) to be a specific width (e.g. 5 mm) wider than the kerf of the cut (extra width RR, FIGS. 6, 6A). Similarly, by way of another example, the user may program the software that operates the machine that it is desired to make a ribmeat cut (Dy—FIG. 6) a specific distance (e.g. 2, 5, 10 mm, etc.) outboard of the determined cutting path (Dz—FIG. 6) to cut off the identified ribmeat to make the chicken breast piece larger than it would have been if the cut had been made along the determined cutting path. Other user preferences to otherwise alter the cutting strategy based upon preferences for the size and shape or extent of the cut pieces may be provided, and one of ordinary skill in the art with a thorough review and understanding of this disclosure will be able to program the machine to alter the cutting strategy in view of user preferences with merely routine optimization.

Another possible user preference is to alter (812/814) the determined cutting strategy in view of the established most likely locations of the predetermined anatomical feature and the one or more other anatomical features to establish a preference to avoid narrow features (such as peninsula TT, FIGS. 6, 6A) that extend a piece cut from the meat block that are established during the cutting process. Specifically, the user preference may be provided such that the cutting strategy that is used (based upon the established most likely location of the predetermined and one or more anatomical features) to avoid establishing a peninsula of meat that has a width (SS) along the peninsula or in some embodiments at an location within the peninsula that is smaller than a specified width, such as 10 mm, 15 mm, 20 mm, or the like. The user preference may additionally or alternatively, be programmed to avoid a peninsula that has two opposite edges that include best fit lines (198, 199) along the edges that form an angle (α, FIG. 6A) with each other that is less than a desired angle, such as 25 degrees, 30 degrees, 35 degrees, 40 degrees, or 45 degrees. The angle α between the best fit lines 198, 199 along the edges of the peninsula (TT) if smaller than desired would result in a narrow peninsula of meat that extends from the meat body that may be considered to be undesirable for a cut food block for further processing/cutting or for cooking, baking, or packaging for sale. Accordingly, as depicted in FIG. 6A the cutting strategy which if followed exactly per the borders of established most likely position of an anatomical feature to be removed (e.g. rear edge fat) (Bz, FIG. 6A) may result in a cutting line that would establish a peninsula (TT) wherein best fit lines through the opposite edges had an angle α smaller than desired, or would result in a width (SS) of the peninsula being smaller than desired. In this circumstance, the cutting strategy would be altered (cut Bx—broken line FIG. 6A) to make a cut to avoid establishing the peninsula with the undesired size or shape.

In other embodiments, the one or more pre-programmed user preferences to alter the cutting strategy (812/814) includes a preference for establishing an outer edge of a portion of the food block that is established with one or more cuts upon the food block that does not have a smaller interior angle (not shown, but a feature similar to peninsula TT in FIGS. 6, 6A that is formed natural upon the food block and not as a result of a cut B, C, D, E upon the food block) between best fit lines (similar to 198, 199) through an outer edge of the piece that establishes the feature that is smaller than a predetermined angle and does not extend outwardly from a body of a cut piece for more than a given percentage of an overall dimension across the cut piece in the direction of a center of the predetermined angle (e.g. the narrow feature extends 25 mm if the overall dimension in the same direction is 230 mm), wherein the predetermined angle is about 75 degrees, or is about 65 degrees, or is about 55 degrees, or is about 45 degrees, or is about 35 degrees, and wherein the given percentage of extension with respect to the overall dimension is more than 25 percent, or more than 20 percent, or more than 15 percent, or more than 10 percent, or more than 5 percent. The specific minimum interior angle or the specific percentage of extension may be selected by the user of the machine. The method may be programmed to include different minimum angles or extensions for different features (e.g. an extension created by a cut for a ribmeat portion may have different minimum angles or extension percentages than an extension created by a rear edge fat cut). In this potential programmed instructions the method would be configured to cut portions of the food block that have these undesired small features even in areas of the food block that are not modified by cuts A, B, C, D, or E.

The method, when used by the machine results in an improvement of the performance of the machine in cutting food blocks (such as individual chicken breasts) that are placed upon a conveyor to lead into the machine and results in a throughput of food blocks cut into several pieces as desired by a user and allows the machine to cut individual food pieces at a throughput that would be physical impossible for one or more human operators to process and cut manually. The method, when used by the machine is transformative to the operation of the machine, because the method allows the machine to determine with a high degree of reliability the location upon each specific food block of various anatomical features upon the food block, with the location of the determined anatomical features being critical for cutting the food block into several pieces as desired by the operator of the machine. The method, when used by the machine, is transformative to the operation of the machine, because the method allows the machine allows for a determination of various anatomical features upon a food block that is imaged and a preparation of a strategy to cut the food block based upon the located anatomical features, with the method being able to take machine operator preferences into account when preparing the cutting strategy.

The method, when used by a machine is transformative to the operation of the machine because it allows for an automated determination when a food block is placed onto a conveyor that leads into the machine in an orientation or position that is offset or at an angle with respect to a projected line upon the conveyor, and the method results in the determination of the location of two or more anatomical features upon the food block and the preparation of a cutting strategy upon the food block that properly cuts the food block as desired by the user with the food block at the determined offset or angle when the conveyor positions the food block to be cut.

Turning now to FIG. 1, a machine 10 is provided, which is configured for receiving a plurality of individual food blocks (such as a plurality of chicken breasts) thereon, obtain an image (300, 400) of the upwardly facing surface of the food block upon a conveyor (e.g. the images on FIG. 1A, compare the image to a library of images (e.g. the images of FIGS. 2A and 2B) of the same type of food block that have been annotated to identify a plurality of anatomical features upon the food block (e.g. the annotations depicted upon the images of FIGS. 2A and 2B, cross-hatching and line outlining each feature, identify the most likely location of those anatomical features upon the imaged food block, develop a cutting strategy (810, FIG. 5) for the imaged food block by a cutting system 310, 311 of the machine, and once the conveyor 30 has moved the food block to a position below or within the range of the cutting system (500, FIG. 1), cutting the food block with one or more cuts to obtain at least two pieces of the food block (YY, ZZ) for further use.

The machine 10 includes a conveyor 30 that moves receives a food block 100, and more specifically a plurality of food blocks thereon in a spaced apart manner (100, 101, 102), and transfers the food block through the machine. The conveyor 30 may move the food block through the entire machine at a constant velocity, or in some embodiments, the conveyor may be a plurality of different conveyors 31, 32 aligned in series (so that the food block can move from an end of a first conveyor 31 onto a second conveyor 32) so that the food block is moved at different velocities within different portions of the machine (i.e. a first velocity when the food block is positioned to obtain an image of the food block (section 400, FIG. 1), and a second slower velocity when the food block is positioned to be cut by the machine with the developed cutting strategy (section 500, FIG. 1).

The machine includes a cutting system 310 that is configured to cut a food block 102 that is disposed below the cutting system 310 or neighboring the cutting system upon the conveyor. The cutting system 310 may be a water jet cutter that is configured to move in one or both (simultaneously or in series) X and Y horizontal directions. The water jet 311 has a nozzle from high a stream of high pressure water leaves, which will establish cuts in a food block 102 that is positioned proximate to the stream of high pressure water (position 500). The machine has a controller 600 (schematic) that establishes a X/Y movement path for the nozzle 312 to establish one or more cutting lines (e.g. A, B, C, D, E) that interact with the food block 102 below or proximate to the nozzle to result in the desired cuts upon the food block. The controller 600 establishes the X/Y movement path for the nozzle 312 to take into account the movement of the food block below the nozzle or proximate to the nozzle with the known velocity of the conveyor 32 that the food block 102 rests upon.

The machine includes an image scanner 300 that is disposed upstream of the cutting system 310, such that a food block 100 that rests upon the conveyor 30 passes by or under the image scanner 300 due to the motion of the conveyor 31 before the food block 101 is passed to the cutting system 310 due to the motion of the conveyor. The cutting system 310 is spaced downstream from the image scanner 300 for a distance (based upon the velocity of the conveyor 30, i.e. a constant velocity in embodiments therewith, or based upon a time to translate a distance based upon a combination of conveyors 31, 32 in series that may have different velocities) that is sufficient for the control system 600 to prepare an image of the food block, compare the image of the food block to a library with a plurality of stored images of the same type of food block that are annotated to identify two or more predetermined anatomical features of the food block 804, establish a most likely location of the anatomical features upon the food block based 806, 808, and prepare a strategy 810 to cut the food block based upon the location of the two or more identified anatomical features upon the imaged food block before the food block reaches the cutting system X due to movement with the conveyor.

FIG. 1A represents a scanned image 20 of a representative food block 101, in this case a chicken breast, to be cut, initially into individual separate pieces (127, 128 that are individual chicken breast pieces) that are either individually saleable or usable, or individual pieces that are disposed to be further cut into desired smaller pieces for sale or further use. In the images a chicken breast is presented, with the machine using the method obtains an image 20 (such as a photograph, an x-ray image, a greyscale image, an image from wavelengths that are not visible to the human eye, an ultrasound image, or the like) of the food block 101 to identify the geometry and quality of the food block presented.

The image 20 may be a photographic image, or it may be an image that is prepared by other than a photograph of the surface of the food block. For example, the image 20 may be prepared by moving the food block past an image scanner 300 along a conveyor 30. The image scanner 300 is configured to scan a specific portion of the food block along the width of the food (X direction) for a specific length of the food block (Y direction). The scanner 300 may identify the height (direction Z, into the page that FIG. 1A is printed on) perpendicular to directions X and Y) of the portion of the food block that is aligned with the sensor 300, specifically the height profile along the width of the specific width being scanned (FIG. 1C depicts thicker portions with #symbols and thinner with @ symbols. The scanner 300 may also scan the color (or grayscale image) of the food block along each width scan, with the color representing the type of localized portion of the food block—i.e. a light color representing fat (P), a darker color representing muscle (R), annotated in FIG. 1C. In some embodiments, color may be representative of the localized thickness, especially a localized thickness within a same portion of the meat block (i.e. in a ribmeat section, a portion that has a lighter color is thicker than a portion of the ribmeat section that has a darker color). Alternatively or additionally, the scanned image may vary based upon its pixel intensity in certain areas of the image, with areas that are more intense (i.e. brighter or more uniform) are calibrated to a type of localized portion of the food block. For example, the scanned image may vary based upon its pixel intensity in certain portions of the image, with the intensity being representative of areas of fat, rib meat, or keel.

One of ordinary skill in the art with a thorough knowledge and understanding of this disclosure as well as the output of the scanned line ZZ based upon the type of scanning system 300 that is being used, would be able to calibrate the system to take knowledge about the localized portion of the food block and use that data within the methods discussed herein. For the sake of brevity - each of these possibilities are collectively referred to as image quality. In other words, image quality can include one or more of image color, image spread, image intensity as discussed herein (as well as possible combinations of two or more of these—i.e. a combination of image color and image spread, or a combination of image spread and image intensity—, with the system being programmed to determine the characteristic of that localized portion based upon the image quality at specific portions along portions of the image. The system saves the data representative of the height at a specific position (e.g. in 1 mm sections along the width, e.g. YY₁, YY₂, YY₃ ..., YY_{Z}) along scanned width lines (XX₁, XX₂, etc.) along the width as well as the identified color at a specific position along the width and saves all of each different width. As a result, the system has data for height and image quality along every individual area (e.g. QQ₁, QQ₂, QQ₃ ..., QQ_{z}) (each individual area is referred to herein as an individual pixel) of the surface of the food block (such as every square mm per the example herein) of the food block once all of the width sections are scanned to form the entire length of the food block. In some embodiments, the width “slices” that are scanned may have a dimension in the length direction of 1 mm, 0.5 mm, 1.5 mm, 2 mm or the like - based upon the accuracy needed as well as based upon the processing power of the system. Similarly, each width slice may be separated into 1 mm segments (or 0.5 mm. 1.5 mm, 2.0 mm, or the like) such that each scanned unit (QQ) is, for example 1.0 mm squared of surface of the food block.

The image includes the measured image qualities for each section of each width - and therefore provides an image that is representative of the appearance of the top surface of the food block, and the combined scanned image quality (in embodiments where image color is directly scanned—or color being imputed into the image where color is indirectly scanned as a function of other types of image quality that are predictive of color) placed next to each other represent the areas of the food block that have a high concentration of fat (P) and other areas that have high concentration of muscle (R). The system also can prepare an image that is color coded or in grayscale where different colors represent different heights of the food block (or different shades of grayscale in a grayscale image represents different heights of the food block. The images that are prepared under this example method are used to optimize the cutting strategy of the food block as discussed herein.

By geometry, the system identifies the width (along the X direction) and the length (along the Y direction) of the food block 102 that is being monitored, and specifically identifies the geometric position of the outer edges A3, A4, A5, A6 of the food block upon a coordinate system, from the perspective of that the image is prepared. In preferred embodiments, the image is representative of the top surface of the food block as it rests upon the moving apparatus (e.g. the surface of the conveyor) and therefore the geometry that is identified is the projection of the length (front to back—along the direction that the food item moves along the conveyor) and the width (left to right, perpendicular to the front to back, with the width directions generally parallel to the direction of movement of the food block along the conveyor. Preferably the image prepared with the food item resting upon (or in the same image as) a reference grid of a known size, so that the various dimensions of the food item can be calculated with reference to the known dimensions of the reference grid. Additionally, as discussed below, the system can identify the position of certain identifiable anatomic landmarks within the food item, as well as the size of the anatomic landmarks within the food block 101. Further, the image may be consulted to identify the locations (and the concentration) of portions that are determined to be primarily muscle (e.g. typically the darker portions on a greyscale image) and primarily fat (e.g. typically the lighter portions on a greyscale image). These determined locations may be used to establish the most likely location of the predetermined anatomical feature or the locations of one or more other anatomical features due to the similar positions of tissue that is primarily muscle or fat (as identified by their image color, intensity, or patterns thereof in the annotated images within the reference library as discussed herein.

The machine 10 using the method includes a plurality of stored images 3001, 3002 of the bulk food item. Each stored image 3001, 3002 has been annotated upon the image—or annotated with reference to the stored image such that a system can readily identify the annotations with reference to specific local positions upon the image—and with reference to specific landmarks upon the image, regarding the location upon the stored image of a predetermined anatomical feature associated with the bulk food item. In the embodiment described in detail herein, the predetermined anatomical feature associated with the bulk food item is the keel 121a of the chicken breast. The keel 121a is a large flat bone located between the two sides of the chicken breast. The keel 121a does not include any nutritional value and is typically cut off from the remaining portions of the chicken breast and discarded when preparing chicken breasts for consumption or for further processing.

Because the anatomy of chicken breasts are similar across the species, keels 121a are typically positioned in a similar position relative to the entire chicken breast and with respect to other anatomical landmarks upon the chicken breast. Specifically, for chicken breasts that are the same general size and have the same general shape, the position of the keel 121a will be in generally the same position for all of the chicken breasts of the same general size and with the same general shape, and the position of other anatomical features (i.e. ribmeat 122a, 123a that exists on an opposite side from each keel, and rear edge fat 125a, 126a that often exists on an outer edge proximate to the keel 121a (i.e. on an outer edge that extends from the keel 121a and is generally perpendicular to an edge that includes the ribmeat 122a, 123a)). Each stored image is annotated with the position of the keel (double hatching) Each stored image is also annotated with the location of the ribmeat 122a, 123a on both opposite outer edges from the keel 121a (e.g. see hatching from 2 to 8 on the clock-face in FIGS. 2A and 2B), and the existence of rear edge fat (attaching from 10 to 4 on the clock face in FIGS. 2A and 2B. The positions of the ribmeat and rear edge fat with respect to the keel may be referenced or stored. Positions may be perpendicular distance of a start and end of the ribmeat from the keel (RR, PP, FIG. 2B), both absolute distance and/or distance as a percentage of a second distance upon the image (e.g. length of the keel, widest distance between opposite edges parallel to keel, etc.). Other relative positions may be angle Θ between lines (196, 197) from a center of the keel within the image to a point at a start of the ribmeat and a second line from the center of the keel within the image to a point at the end of the rib meat. The annotations to identify the location of the rear edge fat with respect to anatomical markers upon the image (which may be similar to the types of annotations to identify the location of the ribmeat) would be provided. Generally, chicken breasts that are larger than a typical breast, will be in the same general shape, such that the annotations (and specifically the relative positions of the features upon the chicken breast) are the same on a larger chicken breast—and the same positions of the features upon the larger chicken breast may be located by increasing the various positional data in proportion to the increase in size of the chicken breast being interpreted with respect to the “nominal” size that is annotated within the database. Preferably, the database of images will have various different sized chicken breasts—so the database will include annotated images that are of a similar size to the chicken breast under interpretation (i.e. that is imaged by the imaging system X).

In some embodiments as depicted in FIG. 2B, an established most likely location and size of an anatomical feature (such as the keel) may be positioned within the body of the chicken breast, but may not reach one or both of the opposite outer edges of the chicken breast that is proximate to the keel and on a best fit line through the keel. In that situation, the method will cause a line Aa to be extended from the determined ends of the anatomical feature that do not extend to the outer edge of the food block to a most proximate position upon the outer edge of the food block, and the step of preparing a strategy for cutting along the predetermined portion will include the step of cutting along the extended line (Aa to A) from the determined ends of the anatomical feature that do no not extend all of the way to the outer edge of the food block to the outer edge of the food block. In this modified method, the entire keel will be cut, and will allow the food block to be cut into two separate pieces. In some embodiments, the keel may be determined to have a specific width (JJ), and the cutting strategy will cut the keel section along both edges of the specific width—and extend only a line (Aa) from an end of the keel that is inboard from the outer edge to the outer edge on one or both sides of the keel as appropriate.

In some embodiments, the annotations in addition to geometry (e.g. length, typical angle of outer edge or transition, relative position from a specific feature) visual aspects upon the image, such as pixel color (and specifically a localized pattern of pixel color) or pixel brightness (and specifically a localized pattern of pixel brightness) would also be saved within the library - and when the annotated feature typically has the same pixel colors, brightnesses, or localized patterns of pixel color/brightness (or similar pixel colors, brightnesses, and patterns) within the annotated range, those pixel colors/brightnesses/localized patterns will also be referenced within the annotated portions, and the comparison of the annotated images within the library with the reference image will look for similarities between the pixel colors/brightnesses/localized patterns within the areas within the geometric positions that are similar to the geometric positions within the annotations within the reference images within the library - either to provide a confirmation of most likely location of the position of the feature if determined solely due to similar geometric position, or to provide an initial most likely location of the feature independently of position upon the image, which is then either confirmed or eliminated based upon a reference of the initial most likely location with the typical geometric position within the library of annotated images.

Those of ordinary skill in the art will readily understand that the method for use in the machine for chicken breasts as discussed herein can be modified for use with bulk food pieces that are other portions of a chicken, or other types of meat (e.g. specific cuts of pork, beef, etc.). The method for use in the machine for other types of bulk food pieces would include a library of images of that type of food item that are annotated for a reference anatomical feature as well as one, two, or more typical anatomical features that are at similar positions across the type of bulk food.

The method includes step 804 comparing the identified image 101 (FIG. 1A) with the plurality of stored images (3001, 3002) to compare the size and shape of the overall food block to prepare a sub-set of the plurality of stored images that are similar to the identified image based upon overall size and shape. After the subset of identified images is prepared step 804 is performed which is comparing the identified image with the subset of images to establish the most likely location of the predetermined anatomical feature (i.e. the keel for chicken breasts) using one or more of the comparisons discussed above.

After the comparison 804 is performed, the most likely location of the predetermined anatomical feature (e.g. the keel X) is determined upon the identified image and the location of the predetermined anatomical feature is mapped onto the image. Then, steps 806, 808 the most likely location of the one or more anatomical features (e.g. the ribmeat upon each side of the chicken breast and the rear edge fat portion) are determined, and those features are mapped onto the image to allow for the method to prepare a cutting strategy 810.

In some embodiments, the machine includes a projected line 201 upon the input of the machine. The image 101 of the bulk food is taken with reference to the projected line 201 upon the image or with respect to a positioning of the food block with respect to the projected line 201 (even if the projected line is not visible on the image 101). In some embodiments, a cutting strategy 810 is prepared with respect to the position of the food block (based upon the image) with respect to the projected line. In this embodiment, system default may be that the projected line 201 (when the image is obtained) extends through the predetermined anatomical feature 121a, such that best line through the predetermined anatomical feature 121z is along the projected line 201 (i.e. there is no angle between the best line through predetermined anatomical feature that is greater than a reference angle (e.g. the angle is less than about 5 degrees or less than about 10 degrees) and the projected line 201 and not later offset therebetween). If the angle is less than about 5 degrees or about 10 degrees, in some embodiments, the angle is disregarded. In these embodiments, it is determined whether there is an offset between the projected line 201 and the best line 121z, including an angle between the projected line 201 and the best line 121z and whether there is a lateral offset between the projected line 201 and the best line 121z. The offset, when determined may in some embodiments be used by the method to establish a cutting strategy of the bulk food as discussed below. In other embodiments, the cutting strategy is determined only based upon the determined most likely locations of the predetermined anatomical feature and the one or more other anatomical features, and therefore the offset is not used in determining the cutting strategy.

Alternatively, in some embodiments, the offset (angle and/or lateral) may be used by the method in the comparison step 804. For example, when a lateral offset is identified, the bulk food may not be centered within the image, as it would have been centered if the best line 121z followed along or crossed the projected line 201. When a lateral offset is identified, the method causes portion of the image that is compared with the reference library to be also moved laterally in the same direction and distance. Similarly, when there is an angled offset, the method adjusts the image at the same angle. When the method adjusts its review of the image (to account for the lateral and/or angled offset) to account for the offset, the comparison step, as discussed above, is then performed such that there is an expected greater likelihood of finding matches between the different identified anatomical features upon the representative images within the library and the image of the food block under consideration.

As discussed herein, a cutting strategy 810 is developed after identification (806, 808) of the most likely location and shape or alignment of the predetermined anatomical feature of the food block as well as the determination of the existence (if any) of the one, two, or more different anatomical features upon the food block. The cutting strategy 810 may be developed with the assistance of an artificial intelligence engine, which may be a machine learning model, which may be a neural network 630 or may be another type of artificial intelligence engine that one of ordinary skill in the art with a thorough review and understanding of this specification would be able to select a specific artificial intelligence engine that would be capable of the comparison of the image of the specific food block with the library of similar annotated food blocks of the same type that are annotated to identify the predetermined anatomical feature and the one or more different anatomical features and the step of establishing most likely location of the predetermined anatomical feature and the one or more different anatomical feature with merely routine optimization of the selected appropriate artificial intelligence system. One of ordinary skill in the art would be able to program the artificial intelligence system to learn pixel colors, intensities, and patterns (and typical sizes of the features and typical locations of the features with reference to the overall size of the food block and with reference to the predetermined anatomical feature) that are present on the annotated images within the library 3001, 3002 (particularly with reference to the annotated areas 121a, 122a, 123a, 125a, 126a, as well as the areas within the images within the library that are proximate to these annotated areas, or areas that typically establish a transition between two or more the annotated areas, and to interpret the image of the food block 101 to select and establish the most likely location upon the image (and therefore the food block from which the image was taken) with typical artificial intelligence programming or learning techniques as known in the art.

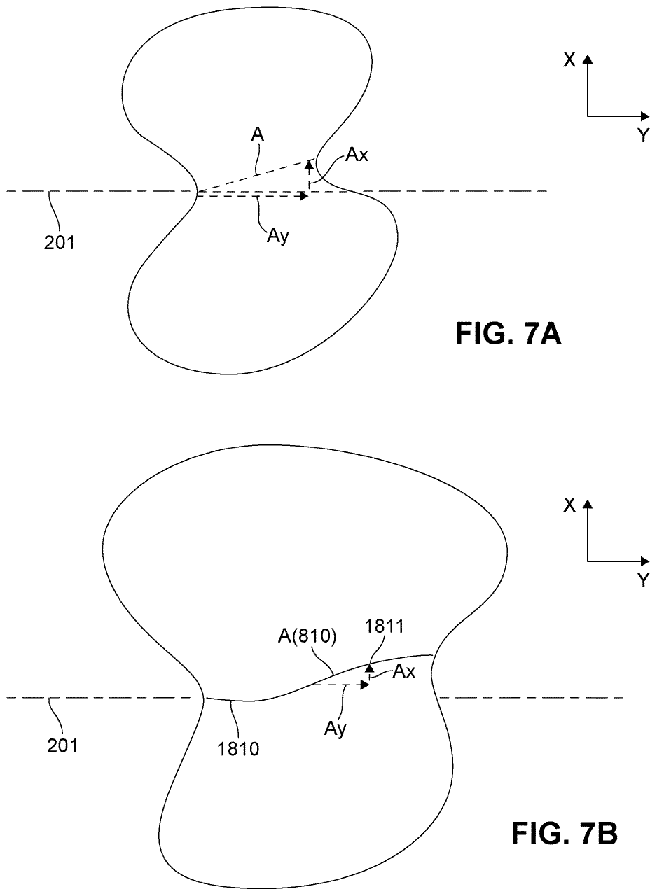

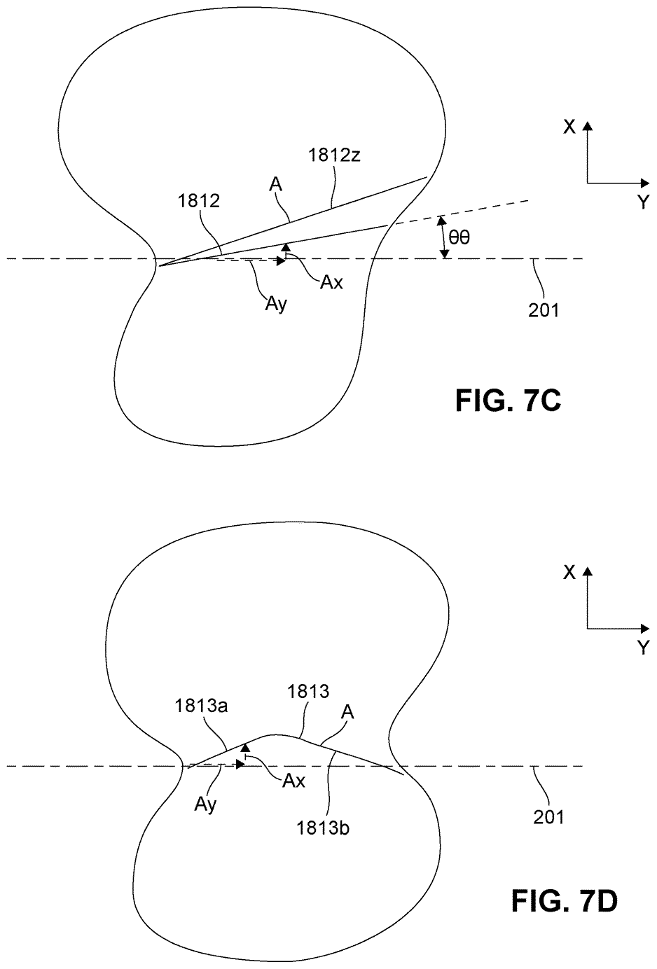

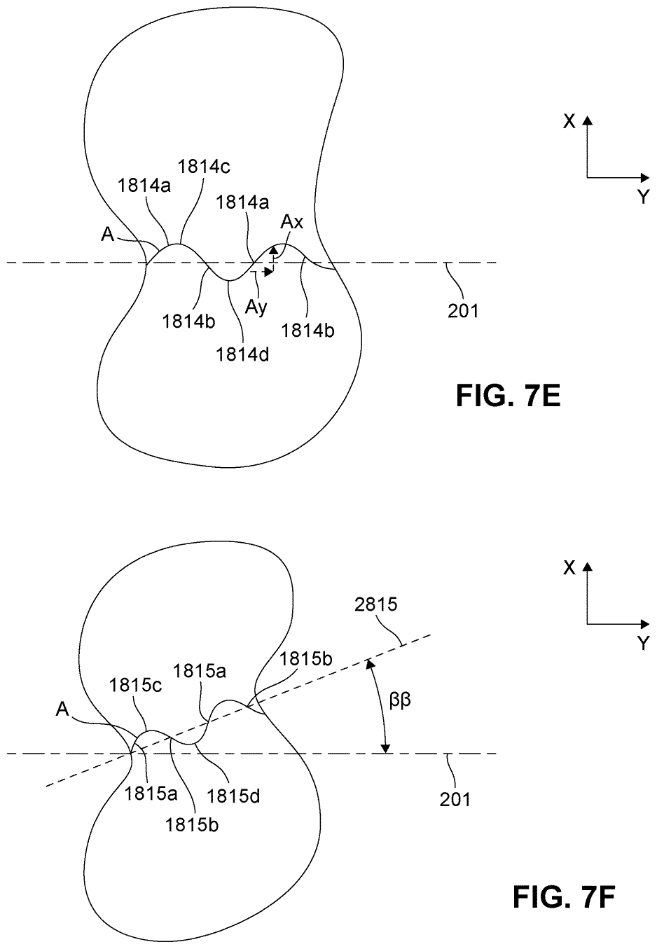

With reference to FIGS. 7A-7F that are schematic depictions of potential cutting strategies, the cutting strategy (810) i.e. the path along a predetermined anatomical feature to be cut (such as a keel 121a of a chicken breast) is not a straight line along an entire length of the cut along the food block. For example as schematically depicted in FIG. 7A, the cutting strategy (which includes a component (Ay) that is parallel to the Y direction, which is parallel to the projected line 201 and a component Ax that is parallel to the X direction, and perpendicular to the component Ay and the Y direction (with both the Ay and Ax components being parallel to the conveyor upon which the food block to be cut rests). In FIG. 7B, the path (810) includes a component Ay that is parallel to the projected line 201, and an component Ax that is perpendicular to the component Ay, wherein the step of cutting the food block based upon the prepared strategy comprises cutting along the path that extends with a varying X component along at least a portion of the entire length of the cut of the food block. In FIG. 7B a first portion of the line (1810) has a component Ax that is constant, and a second portion (1811) that has a component Ax that is changing, and specifically becoming further away from the projected line 201 along the cutting path.

In FIG. 7C, the path (1812) the path includes the varying component Ax component through the entire length of the path. In this embodiment, the path 1812 includes component Ax that that continuously moves in a same relative direction with respect to the projected line (201) along the entire length of the path. In this embodiment, the path 1812 the component Ax additionally continuously moves at the same rate with respect to the projected line along the entire length of the path, such that the path is straight and is at the same acute angle (Θ Θ) with respect to the projected line 201 along the entire length of the path. In a different embodiment, the path (1812z) moves with the component Ax moving in the same direction with respect to the projected line 201 but with a non-constant rate of change, such that the line is curved for a portion of the length of the path or for an entire length of the path.

In another embodiment depicted in FIG. 7D, the path (1813) the component Ax varies such that for a first portion (1813a) moves in a first direction with respect to the projected line 201, and then in a second portion (1813b) after the first portion (1813a) moves in an opposite second direction with respect to the projected line 201. In some embodiments as depicted in FIG. 7E, the path (1814) of the component Ax varies with two or more segments that move in a first direction (1814a) with respect to projected line 201 and two or more segments that move in a second direction (1814b) with respect to the projected line 201, with the portions in the first direction (1814a) alternating with the portions in the second direction (1814b). In some versions of this embodiment, the path 1814 includes the varying X component (and a controlled or constant change of the Ay component to control the cutting as needed) such that the path is similar to a sine wave for at least a portion of the entire length of the path. The term “similar to a sine wave” is intended to include embodiments where the component Ax moves sequentially in opposite directions (1814a, then 1814b, then 1814a, then 1814b, etc.), and moves from a peak (e.g. 1814c) (i.e. position furthest from the projected line 201) and transitions to the opposite direction toward a peak (1814d) in the opposite direction (i.e. a position on an opposite side of the projected line 201 that is furthest from the projected line on that side) and then moving again in the first direction, where generally, the component Ax is constantly changing with respect to the projected line. The term “similar to a sine wave” is satisfied with this general movement of the component Ax even if the rate of change of the component Ax does not form a path 1814 that is exactly line a trigonometric sine wave. The path 1814 may be similar to a sine wave along the entire path, or may be similar to a sine wave with only a portion of the path - with the remaining portion being a straight line or a curve that is not like a sine wave (i.e. the curve only extending in one direction with respect to the projected line).

As depicted in FIG. 7F, a path 1815 may be provided wherein the path extends in a path that is similar to a sine wave that is directed along a direction (2815) that is at an oblique angle (β β) to the projected line 201 (i.e. Y direction) along the entire path or along a portion of the length of the path. The path includes alternating portions in the first direction (1815a) (similar to 1814a) and the second direction (1815b) (similar to 1814b) with the peaks (1815c, 1815d)—with the same peaks (e.g. 1815c) adjacent to each other being at a different X position (i.e. extending generally along direction 2815).

One of ordinary skill in the art with an understanding of the various paths 1811, 1812, 1813, 1814, 1815 discussed above will understand that the method can obtain a cutting path (with the method of determining the path discussed herein) that can include some portions of two or more of the paths 1811, 1812, 1813, 1814, 1815 that are discussed herein in order to best fit the interpreted geometry of the predetermined anatomical feature (e.g. 121—and as depicted in FIGS. 7A-7F the keel 121a of a chicken breast), and these various paths can also be used to establish a cutting path for other anatomical features (e.g. 122, 123, 125, 126 as discussed herein, when identified as present with substantive confidence)—or other lines of cutting to remove various unwanted portions of the food block.

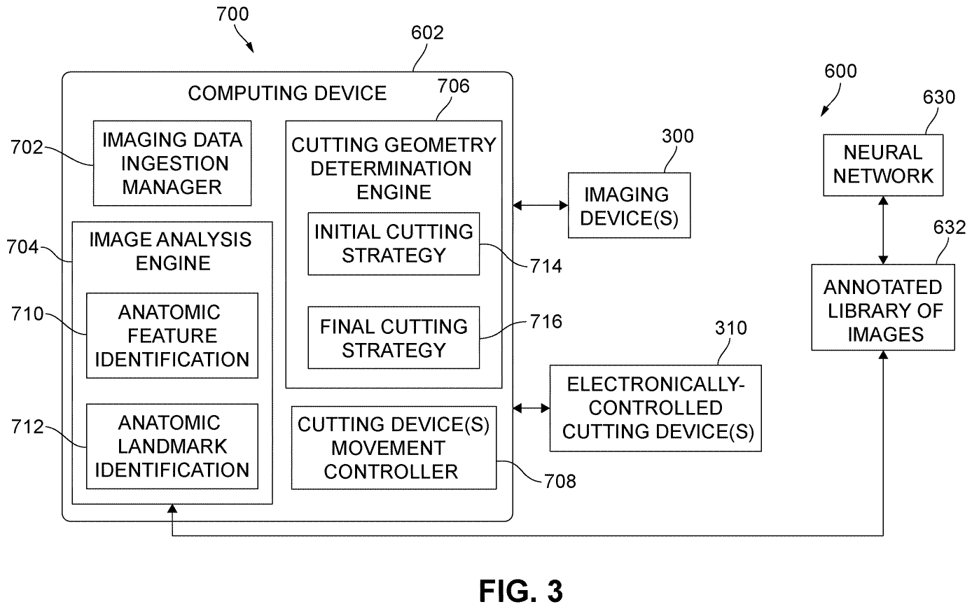

Upon the machine when operating uses the method to establish the most likely location of the predetermined anatomical feature (121) and the one or more additional features (122, 123, 125, 126, when identified as present with a substantial confidence) upon the image of the food block 101 in question, the method then establishes a cutting strategy 810 for the food block once the food block 102 is positioned under or proximate to the cutters 500, 310. The cutting strategy is discussed herein the determination of cutting strategy is depicted schematically in FIGS. 3-5.

The machine when operating under the method then cuts the food block in accordance with the established cutting strategy 816. After the food block is cut by the cutting strategy 103, the conveyor 30 then may bring all of the newly cut pieces (ZZ, YY, BB, CC, DD, EE, FF—section 600) out of the cutting zone 500 (depicted in location 103 of FIG. 1) and potentially to a different part of the machine, or to a different machine for either further processing, cooking, backing, packaging, refrigerating, or freezing or another step with respect to the cut pieces. As discussed herein, some pieces may not be useful (such as rear edge fat (cut pieces BB, CC, or the keel FF, or the ribmeat sections DD, EE) and may be discarded by the machine downstream of the cutting. In some embodiments, pieces that are removed from the chicken breast that are suitable for consumption or processing, but are desired to be differently processed, cooked, stored, packaged etc. (e.g. the ribmeat portion DD, EE that is removed from the chicken breast) is separated from the two chicken breast pieces ZZ, YY and is not passed with the two chicken breast pieces.

The term “about” is specifically defined herein to include a range that includes the reference value and plus or minus 5% of the reference value. The term “substantially the same” is when the item under comparison is within 5% of the aspect of the reference value of the item. The term “substantially” is when the referenced value or referenced aspect is within 5% of the reference value. For example, if the referenced item is an angle, something is substantially at that angle if it is within plus or minus 5% of the angle. The term “substantially” referenced with respect to a state (e.g. a path being substantially blocked) means that referenced state is blocked but may allow for di minimus flow therepast. The term “substantially” is when the term under comparison is not the exact same item (such as shape or length) as mentioned but with only di minimus changes from the referenced item as those di minimus changes would be appreciated by one or ordinary skill in the art, such as changes that do not significantly affect the structure of function of the item.

The computing elements or functions 602 disclosed herein may include a processor 606 and a memory 612 storing computer-readable instructions executable by the processor. The processor can communicate with a neural network 630 (or another type of AI system that is known in the art and would be considered, after a thorough review and understanding of this specification, to be suitable for the methods disclosed herein. The neural network is in communication with the annotated library of images 632 (e.g. images 3001, 3002). The computing device may also have an I/O system 610, a memory 612, data storage 614, and comms systems 616/618 as well as potentially be in communication with peripheral devices 620. The computing device may function over a network 607 that allows communication with the imaging device 300 as well as the cutting devices 310. The memory 612 may store the user preferences or specifications for cut pieces or food block usage as discussed above. The computing device may further include the components as depicted in FIG. 3 (e.g. 702, 704, 706, 708).

In some embodiments, the processor is a hardware processor configured to perform a predefined set of basic operations in response to receiving a corresponding basic instruction selected from a predefined native instruction set of codes. Each of the modules defined herein may include a corresponding set of machine codes selected from the native instruction set, and which may be stored in the memory. Embodiments can be implemented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, optical disc, memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described embodiments can also be stored on the machine-readable medium. Software running from the machine-readable medium can interface with circuitry to perform the described tasks. Moreover, embodiments may be implemented on application specific integrated circuits (ASICs) or very large scale integrated (VLSI) circuits. In fact, persons of ordinary skill in the art may utilize any number of suitable structures capable of executing logical operations according to the embodiments.

Naturally, in view of the teachings and disclosures herein, persons having ordinary skill in the art may appreciate that alternate designs and/or embodiments of the invention may be possible (e.g., with substitution of one or more components for others, with alternate configurations of components, etc.). Although some of the components, relations, configurations, and/or steps according to the invention are not specifically referenced and/or depicted in association with one another, they may be used, and/or adapted for use, in association therewith. All of the aforementioned and various other structures, configurations, relationships, utilities, any which may be depicted and/or based hereon, and the like may be, but are not necessarily, incorporated into and/or achieved by the invention. Any one or more of the aforementioned and/or depicted structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

The specification can be readily understood with reference to the following Numbered Paragraphs:

Numbered Paragraph 1: A method for cutting food in an automated manner, comprising:
preparing a machine to cut a food block into two or more pieces;
establishing a projected line along an inlet into the machine that references a location where a predetermined anatomical feature of the food block to be cut is positioned to align the food block to be properly cut within the machine and downstream of the inlet;
preparing an image of the food block from a side that faces upward when the food block is placed upon the inlet and upon the projected line;
receiving the food block upon the inlet;
comparing the image of the food block with a library that includes a plurality of stored images of a same type of food block, wherein the plurality of stored images are annotated to identify the predetermined anatomical feature as well as one or more additional and different anatomical features of the food block upon the image;
establishing a most likely location of the predetermined anatomical feature and the one or more additional and different anatomical features of the food block that is received upon the inlet based upon a comparison of visible features of the food block upon the image and the annotations of the same predetermined and one or more additional and different anatomical features upon the plurality of stored images,
determining any offset between a position of the food block that is received upon the inlet and the projected line;
preparing a strategy for cutting the food block that is received upon the inlet based upon the established most likely locations of the two or more anatomical features of the food block that is received upon the inlet and the determined offset;
cutting the food block based upon the prepared strategy along a path.

Numbered Paragraph 2: The method of Numbered Paragraph 1, wherein the step of comparing the image of the food block with the plurality of stored images of the same type of food block is performed by a machine learning model.

Numbered Paragraph 3: The method of either Numbered Paragraphs 1-2, wherein the step of comparing the image of the food block with the plurality of stored images of the same type of food block is performed by an artificial neural network.

Numbered Paragraph 4: The method of any one of the preceding Numbered Paragraphs, wherein the food block is a chicken breast, and the predetermined anatomical feature is a keel of the chicken breast, wherein the food block is positioned upon the inlet such that the anatomical feature assumed to be the keel is positioned along the projected line.

Numbered Paragraph 5: The method of Numbered Paragraph 4, one of the additional and different anatomical features is a ribmeat portion of the food block.

Numbered Paragraph 6: The method of Numbered Paragraph 5, wherein the strategy for cutting the food block that is received upon the inlet establishes a portion of the food block that is to be cut along the keel to establish first and second halves of the food block and a portion of the food block that is to be cut to remove the ribmeat portion from the food block.

Numbered Paragraph 7: The method of Numbered Paragraph 6, further processing the ribmeat portion that is removed from the food block and not passing the removed ribmeat portion out of the machine with the first and second halves of the food block.

Numbered Paragraph 8: The method of any one of the preceding Numbered Paragraphs, wherein the machine cuts the food block based upon the prepared strategy using one or more water jets.

Numbered Paragraph 9: The method of anyone of Numbered Paragraphs 4-8, further comprising determining whether the food block that is positioned such that the anatomical feature assumed to be the keel is placed along or proximate to the projected line, or whether the food block is positioned such that the anatomical feature assumed to be the keel is positioned with a lateral offset from the projected line and/or whether the food block is positioned such that the anatomical feature assumed to be the keel is positioned such that a best fit straight line through the anatomical feature assumed to be the keel is disposed at an acute angle with respect to the projected line.

Numbered Paragraph 10: The method of Numbered Paragraph 9, wherein if it is determined that that the anatomical feature assumed to be the keel is positioned with the lateral offset from the projected line, the step of preparing the strategy for cutting the food block that is received upon the inlet to offset the cuts of the food block is performed laterally at the same length as the determined lateral offset.

Numbered Paragraph 11: The method of Numbered Paragraph 9, wherein if it is determined that the anatomical feature assumed to be the keel is positioned such that the assumed keel is at the best fit straight line through the assumed keel is disposed at the acute angle with respect to the projected line, the step of preparing the strategy for cutting the food block that is received upon the inlet to cut the food block with is performed with cuts that are offset from the prepared strategy at the acute angle.

Numbered Paragraph 12: The method of Numbered Paragraph 9, wherein if it is determined that the anatomical feature assumed to be the keel is positioned with the lateral offset from the projected line and it is determined that the anatomical feature assumed to be the keel is positioned such that the assumed keel is at the best fit straight line through the assumed keel is disposed at the acute angle with respect to the projected line, the step of preparing the strategy for cutting the food block that is received upon the inlet is performed to offset the cuts of the food block laterally at the same length as the determined lateral offset, and the step of preparing the strategy for cutting the food block that is received upon the inlet to cut the food block is performed with cuts that are offset from the prepared strategy at the acute angle.

Numbered Paragraph 13: The method of Numbered Paragraph 8, wherein the determining whether the food block is positioned such that the anatomical feature assumed to be the keel is positioned such that a best fit straight line through the anatomical feature assumed to be the keel is disposed at an acute angle with respect to the projected line, the value of the acute angle is compared with a lowest reference acute angle, and if the acute angle is less than the lowest reference acute angle, the position of the food block at the acute angle is neglected when preparing the strategy for cutting the food block that is received upon the inlet is performed.

Numbered Paragraph 14: The method of any one of the preceding Numbered Paragraphs, wherein the library that includes the plurality of stored images of the same type of food block is annotated to identify a thickness of each portion the food block depicted within each image based upon a pixel color at each location within each image.

Numbered Paragraph 15: The method of any one of the preceding Numbered Paragraphs, wherein the library that includes the plurality of stored images of the same type of food block is annotated to reference the one or more additional and different anatomical features of the food block upon each stored image based upon a relative position of each of the one or more additional and different anatomical features upon the image with respect to a location of the predetermined anatomical feature and/or based upon an identified thickness of the one or more additional and different anatomical features based upon a localized color within each image.

Numbered Paragraph 16: The method of any one of the preceding Numbered Paragraphs, wherein the library that includes the plurality of stored images of the same type of food block is annotated to reference the one or more additional and different anatomical features of the food block upon each stored image based upon a relative position of each of the one or more additional and different anatomical features upon the image with respect to a location of the predetermined anatomical feature and based upon a pattern of localized colors and brightness of the one or more additional and different anatomical features based upon a localized color and brightness within each image.

Numbered Paragraph 17: The method of any one of the preceding Numbered Paragraphs, wherein if the likely location of the predetermined anatomical feature that is established does not extend all of the way to an outer edge of the food block upon one or both ends of the likely location, extending a line from determined ends of the anatomical feature that do not extend to the outer edge of the food block to a most proximate position upon the outer edge of the food block, and preparing the strategy for cutting along the extended line from the determined ends of the anatomical feature that do no not extend all of the way to the outer edge of the food block to the outer edge of the food block.

Numbered Paragraph 18: The method of any one of the preceding Numbered Paragraphs, wherein the inlet includes a conveyor that moves the food block with respect to the machine from the inlet and to a location where the food block is cut based upon the prepared strategy, wherein the conveyor moves the food block at a speed such that it would not be possible for a human operator to manually cut the food block placed upon the moving conveyor in a manner that would result in the food block being cut into pieces as the food block would be cut when the machine cuts the food block based upon the prepared strategy.

Numbered Paragraph 19: The method of any one of the preceding Numbered Paragraphs, wherein the step of preparing a strategy for cutting includes altering the strategy for cutting based upon one or more pre-programed user preferences for altering the strategy for cutting.

Numbered Paragraph 20: The method of Numbered Paragraph 19, wherein the one or more pre-programed user preferences includes a preference for a width of a cut along the predetermined anatomical feature to a thickness that is larger than a minimum cutting width of the machine.

Numbered Paragraph 21: The method of Numbered Paragraph 19, wherein the one or more pre-programed user preferences includes a preference for forming a peninsula of meat as a result of a cut that has a width along or at a point within the peninsula that is smaller than a specified width.

Numbered Paragraph 22: The method of any one of the preceding Numbered Paragraphs, wherein the prepared strategy for cutting the food block includes cutting the food block along a line associated with the predetermined anatomical feature.

Numbered Paragraph 23: A method for cutting food in an automated manner, comprising:
preparing a machine to cut a food block into two or more pieces;
establishing a projected line along an inlet into the machine that references a location where a predetermined anatomical feature of the food block to be cut is positioned to align the food block to be properly cut within the machine and downstream of the inlet;
preparing an image of the food block from a side that faces upward when the food block is placed upon the inlet and upon the projected line;
receiving the food block upon the inlet;
comparing the image of the food block with a library that includes a plurality of stored images of a same type of food block, wherein the plurality of stored images are annotated to identify the predetermined anatomical feature as well as one or more additional and different anatomical features of the food block upon the image;
establishing a most likely location of the predetermined anatomical feature and the one or more additional and different anatomical features of the food block that is received upon the inlet based upon a comparison of visible features of the food block upon the image and the annotations of the same predetermined and one or more additional and different anatomical features upon the plurality of stored images,
preparing a strategy for cutting the food block that is received upon the inlet based upon the established most likely locations of the two or more anatomical features of the food block that is received upon the inlet, wherein the prepared strategy includes a cut line through the food block that is along a line along the predetermined anatomical feature from a first outer edge of the food block either at or closest to a first determined end of the predetermined anatomical feature and to a second outer edge of the food block at an opposite side of the food block from the first outer edge and either at or closest to an opposite second determined end of the predetermined anatomical feature; and
cutting the food block based upon the prepared strategy along a path.

Numbered Paragraph 24: The method of Numbered Paragraph 23, wherein the step of comparing the image of the food block with the plurality of stored images of the same type of food block is performed by a machine learning model.

Numbered Paragraph 25: The method of any one of Numbered Paragraphs 23 or 24, wherein the step of comparing the image of the food block the plurality of stored images of the same type of food block is performed by an artificial neural network.

Numbered Paragraph 26: The method of any one of Numbered Paragraphs 23-25, wherein the food block is a chicken breast, and the predetermined anatomical feature is a keel of the chicken breast, wherein the food block is positioned upon the inlet such that the anatomical feature assumed to be the keel is positioned along or proximate to the projected line.

Numbered Paragraph 27: The method of Numbered Paragraph 26, one of the additional and different anatomical features is a ribmeat portion of the food block.

Numbered Paragraph 28: The method of Numbered Paragraph 27, wherein the cut line through the food block that is along the line along the predetermined anatomical feature which is the keel is provided to establish first and second halves of the food block and a second cut line is provided upon a portion of the food block that is to be cut to remove the ribmeat portion from the food block.

Numbered Paragraph 29: The method of Numbered Paragraph 28, further processing the ribmeat portion that is removed from the food block is further processed and not passing the removed ribmeat portion out of the machine with the first and second halves of the food block.

Numbered Paragraph 30: The method of any one of Numbered Paragraphs 23-29, wherein the machine cuts the food block based upon the prepared strategy using one or more water jets that are configured to cut food that are contacted by high pressure water of the one or more water jets.

Numbered Paragraph 31: The method of any one of Numbered Paragraphs 23-30, wherein the library that includes the plurality of stored images of the same type of food block is annotated to identify a thickness of each portion the food block depicted within each image based upon a pixel color at each location within each image.

Numbered Paragraph 32: The method of any one of Numbered Paragraphs 23-31, wherein the library that includes the plurality of stored images of the same type of food block is annotated to reference the one or more additional and different anatomical features of the food block upon each stored image based upon a relative position of each of the one or more additional and different anatomical features upon the image with respect to a location of the predetermined anatomical feature and based upon an identified thickness of the one or more additional and different anatomical features based upon a localized color within each image.

Numbered Paragraph 33: The method of any one of Numbered Paragraphs 23-32, wherein the library that includes the plurality of stored images of the same type of food block is annotated to reference the one or more additional and different anatomical features of the food block upon each stored image based upon a relative position of each of the one or more additional and different anatomical features upon the image with respect to a location of the predetermined anatomical feature and based upon a pattern of localized colors and brightness of the one or more additional and different anatomical features based upon a localized color and brightness within each image.

Numbered Paragraph 34: The method of any one of Numbered Paragraphs 23-33, wherein if the most likely location of the predetermined anatomical feature that is established does not extend all of the way to an outer edge of the food block upon one or both ends of the most likely location, extending a line from determined ends of the anatomical feature that do not extend to the outer edge of the food block to a most proximate position upon the outer edge of the food block, and preparing the strategy for cutting along the extended line from the determined ends of the anatomical feature that do no not extend all of the way to the outer edge of the food block to the outer edge of the food block.

Numbered Paragraph 35: The method of any one of Numbered Paragraphs 23-34, wherein the inlet includes a conveyor that moves the food block with respect to the machine from the inlet and to a location where the food block is cut based upon the prepared strategy, wherein the conveyor moves the food block at a speed such that it would not be possible for a human operator to manually cut the food block placed upon the moving conveyor in a manner that would result in the food block being cut into pieces as the food block would be cut when the machine cuts the food block based upon the prepared strategy.

Numbered Paragraph 36: The method of Numbered Paragraph 35, wherein the conveyor moves at a speed such that an image of new food block that is disposed upon the conveyor along the projected line is prepared less than or equal to every 5 seconds.

Numbered Paragraph 37: The method of Numbered Paragraph 36, wherein the conveyor moves at the speed such that the image of new food block that becomes disposed upon the conveyor along the projected line is less than or equal to every 2 seconds, and preferably less than or equal to every 1 second.

Numbered Paragraph 38: The method of any one of Numbered Paragraphs 23-37, wherein the step of preparing a strategy for cutting includes altering the strategy for cutting based upon one or more pre-programed user preferences for altering the strategy for cutting.

Numbered Paragraph 39: The method of Numbered Paragraph 38, wherein the one or more pre-programed user preferences includes a preference for a width of a cut along the predetermined anatomical feature to a thickness that is larger than a minimum cutting width of the machine.

Numbered Paragraph 40: The method of Numbered Paragraph 38, wherein the one or more pre-programed user preferences includes a preference for forming a peninsula of meat as a result of a cut that has a width along or at a point within the peninsula that is smaller than a specified width.

Numbered Paragraph 41: The method of Numbered Paragraph 38, wherein the one or more pre-programmed user preferences includes a preference for establishing an outer edge of a portion of the food block that is established with one or more cuts upon the food block that does not have a smaller interior angle than a predetermined angle and does not extend outwardly from a body of a cut piece for more than a given percentage of an overall dimension across the cut piece in the direction of a center of the predetermined angle, wherein the predetermined angle is about 75 degrees, or is about 65 degrees, or is about 55 degrees, or is about 45 degrees, or is about 35 degrees, and wherein the given percentage of the overall dimension is more than 25 percent, or more than 20 percent, or more than 15 percent.

Numbered Paragraph 42: A method for cutting food in an automated manner, comprising:
preparing a machine to cut a food block into two more pieces;
establishing a projected line along an inlet into the machine that references a location where a predetermined anatomical feature of the food block to be cut is positioned to align the food block to be properly cut within the machine and downstream of the inlet;
preparing an image of the food block from a side that faces upward when the food block is placed upon the inlet and upon the projected line;
receiving the food block upon the inlet;
comparing the image of the food block with a library that includes a plurality of stored images of a same type of food block, wherein the plurality of stored images are annotated to identify the predetermined anatomical feature as well as one or more additional and different anatomical features of the food block upon the image;
establishing a most likely location of the predetermined anatomical feature and the one or more additional and different anatomical features of the food block that is received upon the inlet based upon a comparison of visible features of the food block upon the image and the annotations of the same predetermined and one or more additional and different anatomical features upon the plurality of stored images,
determining any offset between a position of the food block that is received upon the inlet and the projected line;
preparing a strategy for cutting the food block that is received upon the inlet based upon the established most likely locations of the two or more anatomical features of the food block that is received upon the inlet and the determined offset;
cutting the food block along the predetermined anatomical feature based upon the prepared strategy, wherein the step of cutting the food block based upon the prepared strategy comprises cutting the food block along a path that is not a straight line along an entire length of the cut of the food block.

Numbered Paragraph 43: The method of Numbered Paragraph 42 or any one of Numbered Paragraphs 1-41, wherein the path includes a Y component that is parallel to the projected line, and an X component that is perpendicular to the Y component, wherein the step of cutting the food block based upon the prepared strategy comprises cutting along the path that extends with a varying X component along at least a portion of the entire length of the cut of the food block.

Numbered Paragraph 44: The method of Numbered Paragraph 43 or any one of Numbered Paragraphs 1-41, wherein the path includes the varying X component through the entire length of the path.

Numbered Paragraph 45: The method of Numbered Paragraph 44 or any one of Numbered Paragraphs 1-41, wherein the path includes the varying X component that continuously moves in a same relative direction with respect to the projected line along the entire length of the path.

Numbered Paragraph 46: The method of Numbered Paragraph 45 or any one of Numbered Paragraphs 1-41, wherein the path includes the varying X component that continuously moves at the same rate with respect to the projected line along the entire length of the path.

Numbered Paragraph 47: The method of Numbered Paragraph 44 or any one of Numbered Paragraphs 1-41, wherein the path includes the varying X component that for a first portion moves in a first direction with respect to the projected line, and then in a second portion after the first portion moves in an opposite second direction with respect to the projected line.

Numbered Paragraph 48: The method of Numbered Paragraph 47, or any one of Numbered Paragraphs 1-41, wherein the path includes the varying X component that is similar to a sine wave for at least a portion of the entire length of the path.

Numbered Paragraph 49: The method of Numbered Paragraph 48 or any one of Numbered Paragraphs 1-41, wherein the path includes the varying X component that is similar to a sine wave for a majority of the entire length of the path.

Numbered Paragraph 50: The method of Numbered Paragraph 42, or any one of Numbered Paragraphs 1-41, wherein the path includes a Y component that is parallel to the projected line, and an X component that is perpendicular to the Y component, wherein the path is at an oblique angle to both the X component and the Y component, wherein the path includes a varying X component along at least a portion of the entire length of the path upon the food block, wherein the varying X component for a first portion of the path moves in a first direction with respect to the projected line, and then in a second portion of the path after the first portion moves in an opposite second direction with respect to the projected line.

Numbered Paragraph 51: The method of Numbered Paragraph 50 or any one of Numbered Paragraphs 1-41, wherein the varying X component varies with a non-constant rate of change along at least a portion of the entire length of the path upon the food block.

Numbered Paragraph 52: The method of Numbered Paragraph 51 or any one of Numbered Paragraphs 1-41, wherein the varying X component varies with a non-constant rate of change along at least a majority of the entire length of the path upon the food block.

Numbered Paragraph 53: The method of Numbered Paragraph 42 or any one of Numbered Paragraphs 1-41, wherein the path includes a Y component that is parallel to the projected line, and an X component that is perpendicular to the Y component, wherein the path is at an oblique angle to both the X component and the Y component for a least a portion of the path.

Numbered Paragraph 54: The method of Numbered Paragraph 53 or any one of Numbered Paragraphs 1-41, wherein the path extends in a path that is similar to a sine wave that is directed in a direction that is at an oblique angle to both the X component and the Y component in the portion that is at the oblique angle to both the X component and the Y component of the path.

1. A method for cutting food in an automated manner, comprising:
preparing a machine to cut a food block into two or more pieces;
establishing a projected line along an inlet into the machine that references a location where a predetermined anatomical feature of the food block to be cut is positioned to align the food block to be properly cut within the machine and downstream of the inlet;
preparing an image of the food block from a side that faces upward when the food block is placed upon the inlet and upon the projected line;
receiving the food block upon the inlet;
comparing the image of the food block with a library that includes a plurality of stored images of a same type of food block, wherein the plurality of stored images are annotated to identify the predetermined anatomical feature as well as one or more additional and different anatomical features of the food block upon the image;
establishing a most likely location of the predetermined anatomical feature and the one or more additional and different anatomical features of the food block that is received upon the inlet based upon a comparison of visible features of the food block upon the image and the annotations of the same predetermined and one or more additional and different anatomical features upon the plurality of stored images,
determining any offset between a position of the food block that is received upon the inlet and the projected line;
preparing a strategy for cutting the food block that is received upon the inlet based upon the established most likely locations of the two or more anatomical features of the food block that is received upon the inlet and the determined offset;
cutting the food block based upon the prepared strategy.

2. The method of claim 1, wherein the food block is a chicken breast, and the predetermined anatomical feature is a keel of the chicken breast, wherein the food block is positioned upon the inlet such that the anatomical feature assumed to be the keel is positioned along the projected line.

3. The method of claim 2, one of the additional and different anatomical features is a ribmeat portion of the food block.

4. The method of claim 3, wherein the strategy for cutting the food block that is received upon the inlet establishes a portion of the food block that is to be cut along the keel to establish first and second halves of the food block and a portion of the food block that is to be cut to remove the ribmeat portion from the food block.

5. The method of claim 4, further processing the ribmeat portion that is removed from the food block and not passing the removed ribmeat portion out of the machine with the first and second halves of the food block.

6. The method of claim 2, further comprising determining whether the food block that is positioned such that the anatomical feature assumed to be the keel is placed along or proximate to the projected line, or whether the food block is positioned such that the anatomical feature assumed to be the keel is positioned with a lateral offset from the projected line and/or whether the food block is positioned such that the anatomical feature assumed to be the keel is positioned such that a best fit straight line through the anatomical feature assumed to be the keel is disposed at an acute angle with respect to the projected line.

7. The method of claim 6, wherein if it is determined that that the anatomical feature assumed to be the keel is positioned with the lateral offset from the projected line, the step of preparing the strategy for cutting the food block that is received upon the inlet to offset the cuts of the food block is performed laterally at the same length as the determined lateral offset.

8. The method of claim 6, wherein if it is determined that the anatomical feature assumed to be the keel is positioned such that the assumed keel is at the best fit straight line through the assumed keel is disposed at the acute angle with respect to the projected line, the step of preparing the strategy for cutting the food block that is received upon the inlet to cut the food block is performed with cuts that are offset from the prepared strategy at the acute angle.

9. The method of claim 6, wherein if it is determined that the anatomical feature assumed to be the keel is positioned with the lateral offset from the projected line and it is determined that the anatomical feature assumed to be the keel is positioned such that the assumed keel is at the best fit straight line through the assumed keel is disposed at the acute angle with respect to the projected line, the step of preparing the strategy for cutting the food block that is received upon the inlet is performed to offset the cuts of the food block laterally at the same length as the determined lateral offset, and the step of preparing the strategy for cutting the food block that is received upon the inlet to cut the food block is performed with cuts that are offset from the prepared strategy at the acute angle.

10. The method of claim 5, wherein the determining whether the food block is positioned such that the anatomical feature assumed to be the keel is positioned such that a best fit straight line through the anatomical feature assumed to be the keel is disposed at an acute angle with respect to the projected line, the value of the acute angle is compared with a lowest reference acute angle, and if the acute angle is less than the lowest reference acute angle, the position of the food block at the acute angle is neglected when preparing the strategy for cutting the food block that is received upon the inlet is performed.

11. The method of claim 1, wherein the library that includes the plurality of stored images of the same type of food block is annotated to identify a thickness of each portion the food block depicted within each image based upon a pixel color at each location within each image.

12. The method of claim 1, wherein the library that includes the plurality of stored images of the same type of food block is annotated to reference the one or more additional and different anatomical features of the food block upon each stored image based upon a relative position of each of the one or more additional and different anatomical features upon the image with respect to a location of the predetermined anatomical feature and/or based upon an identified thickness of the one or more additional and different anatomical features based upon a localized color within each image.

13. The method of claim 1, wherein the library that includes the plurality of stored images of the same type of food block is annotated to reference the one or more additional and different anatomical features of the food block upon each stored image based upon a relative position of each of the one or more additional and different anatomical features upon the image with respect to a location of the predetermined anatomical feature and based upon a pattern of localized colors and brightness of the one or more additional and different anatomical features based upon a localized color and brightness within each image.

14. The method of claim 1, wherein if the likely location of the predetermined anatomical feature that is established does not extend all of the way to an outer edge of the food block upon one or both ends of the likely location, extending a line from determined ends of the anatomical feature that do not extend to the outer edge of the food block to a most proximate position upon the outer edge of the food block, and preparing the strategy for cutting along the extended line from the determined ends of the anatomical feature that do no not extend all of the way to the outer edge of the food block to the outer edge of the food block.

15. The method of claim 1, wherein the inlet includes a conveyor that moves the food block with respect to the machine from the inlet and to a location where the food block is cut based upon the prepared strategy, wherein the conveyor moves the food block at a speed such that it would not be possible for a human operator to manually cut the food block placed upon the moving conveyor in a manner that would result in the food block being cut into pieces as the food block would be cut when the machine cuts the food block based upon the prepared strategy.

16. The method of claim 1, wherein the step of preparing a strategy for cutting includes altering the strategy for cutting based upon one or more pre-programed user preferences for altering the strategy for cutting.

17. The method of claim 16, wherein the one or more pre-programed user preferences includes a preference for a width of a cut along the predetermined anatomical feature to a thickness that is larger than a minimum cutting width of the machine.

18. A method for cutting food in an automated manner, comprising:
preparing a machine to cut a food block into two or more pieces;
establishing a projected line along an inlet into the machine that references a location where a predetermined anatomical feature of the food block to be cut is positioned to align the food block to be properly cut within the machine and downstream of the inlet;
preparing an image of the food block from a side that faces upward when the food block is placed upon the inlet and upon the projected line;
receiving the food block upon the inlet;
comparing the image of the food block with a library that includes a plurality of stored images of a same type of food block, wherein the plurality of stored images are annotated to identify the predetermined anatomical feature as well as one or more additional and different anatomical features of the food block upon the image;
establishing a most likely location of the predetermined anatomical feature and the one or more additional and different anatomical features of the food block that is received upon the inlet based upon a comparison of visible features of the food block upon the image and the annotations of the same predetermined and one or more additional and different anatomical features upon the plurality of stored images,
preparing a strategy for cutting the food block that is received upon the inlet based upon the established most likely locations of the two or more anatomical features of the food block that is received upon the inlet, wherein the prepared strategy includes a cut line through the food block that is along a line along the predetermined anatomical feature from a first outer edge of the food block either at or closest to a first determined end of the predetermined anatomical feature and to a second outer edge of the food block at an opposite side of the food block from the first outer edge and either at or closest to an opposite second determined end of the predetermined anatomical feature; and
cutting the food block based upon the prepared strategy.

19. The method of claim 18, wherein the machine cuts the food block based upon the prepared strategy using one or more water jets that are configured to cut food that are contacted by high pressure water of the one or more water jets.

20. The method of claim 18, wherein the inlet includes a conveyor that moves the food block with respect to the machine from the inlet and to a location where the food block is cut based upon the prepared strategy, wherein the conveyor moves the food block at a speed such that it would not be possible for a human operator to manually cut the food block placed upon the moving conveyor in a manner that would result in the food block being cut into pieces as the food block would be cut when the machine cuts the food block based upon the prepared strategy.

21. The method of claim 20, wherein the conveyor moves at a speed such that an image of new food block that is disposed upon the conveyor along the projected line is prepared less than or equal to every 5 seconds.

22. The method of claim 21, wherein the conveyor moves at the speed such that the image of new food block that becomes disposed upon the conveyor along the projected line is less than or equal to ever 2 seconds, and preferably less than or equal to every 1 second.

23. The method of claim 18, wherein the step of preparing a strategy for cutting includes altering the strategy for cutting based upon one or more pre-programed user preferences for altering the strategy for cutting.

24. The method of claim 23, wherein the one or more pre-programmed user preferences includes a preference for establishing an outer edge of a portion of the food block that is established with one or more cuts upon the food block that does not have a smaller interior angle than a predetermined angle and does not extend outwardly from a body of a cut piece for more than a given percentage of an overall dimension across the cut piece in the direction of a center of the predetermined angle, wherein the predetermined angle is about 75 degrees, or is about 65 degrees, or is about 55 degrees, or is about 45 degrees, or is about 35 degrees, and wherein the given percentage of the overall dimension is more than 25 percent, or more than 20 percent, or more than 15 percent.

25. A method for cutting food in an automated manner, comprising:
preparing a machine to cut a food block into two more pieces;
establishing a projected line along an inlet into the machine that references a location where a predetermined anatomical feature of the food block to be cut is positioned to align the food block to be properly cut within the machine and downstream of the inlet;
preparing an image of the food block from a side that faces upward when the food block is placed upon the inlet and upon the projected line;
receiving the food block upon the inlet;
comparing the image of the food block with a library that includes a plurality of stored images of a same type of food block, wherein the plurality of stored images are annotated to identify the predetermined anatomical feature as well as one or more additional and different anatomical features of the food block upon the image;
establishing a most likely location of the predetermined anatomical feature and the one or more additional and different anatomical features of the food block that is received upon the inlet based upon a comparison of visible features of the food block upon the image and the annotations of the same predetermined and one or more additional and different anatomical features upon the plurality of stored images,
determining any offset between a position of the food block that is received upon the inlet and the projected line;
preparing a strategy for cutting the food block that is received upon the inlet based upon the established most likely locations of the two or more anatomical features of the food block that is received upon the inlet and the determined offset;
cutting the food block along the predetermined anatomical feature based upon the prepared strategy, wherein the step of cutting the food block based upon the prepared strategy comprises cutting the food block along a path that is not a straight line along an entire length of the cut of the food block.

26. The method of claim 25, wherein the path includes a Y component that is parallel to the projected line, and an X component that is perpendicular to the Y component, wherein the step of cutting the food block based upon the prepared strategy comprises cutting along the path that extends with a varying X component along at least a portion of the entire length of the cut of the food block.

27. The method of claim 25, wherein the path includes the varying X component that for a first portion moves in a first direction with respect to the projected line, and then in a second portion after the first portion moves in an opposite second direction with respect to the projected line.

28. The method of claim 47, wherein the path includes the varying X component that is similar to a sine wave for at least a portion of the entire length of the path.

29. The method of claim 25, wherein the path includes a Y component that is parallel to the projected line, and an X component that is perpendicular to the Y component, wherein the path is at an oblique angle to both the X component and the Y component, wherein the path includes a varying X component along at least a portion of the entire length of the path upon the food block, wherein the varying X component for a first portion of the path moves in a first direction with respect to the projected line, and then in a second portion of the path after the first portion moves in an opposite second direction with respect to the projected line,
wherein the varying X component varies with a non-constant rate of change along at least a portion of the entire length of the path upon the food block.
